(19) United States
(12) Patent Application Publication
(10) Pub. No.: US 2006/0208719 A1
(43) Pub. Date: Sep. 21, 2006

(54) Circuit arrangement for controlling voltages

(75) Inventor: Fabrizio Librizzi, Gravina di Catania (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.I., Agrate Brianza (IT)

(21) Appl. No.: 11/360,003

(22) Filed: Feb. 22, 2006

(30) Foreign Application Priority Data
Feb. 22, 2005 (EP) 05003719.1

(51) Int. Cl. G05F 1/00

(52) U.S. Cl. 323/288

(57) ABSTRACT

A control circuit for a pulsed width modulation controller includes a main controlled switch to selectively block an energization signal from a switched mode power supply and a free-wheeling synchronous switch for selectively transferring the energization signal as an output signal. The controller also includes a control circuit that includes: a PWM module having an input terminal, for connection with the switched mode power supply, and a PWM comparator; a drive circuit for the main controlled switch controlled by the PWM comparator; a low-side drive circuit for the free-wheeling synchronous switch controlled by the PWM comparator; and a ramp generator having a synchronization terminal connected to the power supply and a comparator sensing the signal on the synchronization terminal. The ramp signal from the ramp generator defines the threshold of the PWM comparator to thereby control operation of the drive circuits.

### BACKGROUND OF THE INVENTION

1. Field of the Invention

The invention relates to techniques for controlling voltages in electronic devices.

The invention was devised by paying specific attention to techniques for controlling multiple voltages.

2. Description of the Related Art

Several electronic devices require two or more isolated and tightly regulated voltages. For example, microprocessors require a precisely controlled supply voltage of 3.3 V or lower, as well as the traditional 5 V supply.

Furthermore, electronic products continue to decrease in size, demanding higher power densities and higher efficiency. The combination of these trends presents a difficult challenge for design engineers.

Choosing the best approach to generate these multiple voltages requires a deep understanding of the strengths and the weaknesses of the available techniques and of how each technique affects an application. The main selection criteria are cost, power conversion efficiency, and simplicity of manufacture.

A configuration of a conventional switched mode power supply is shown in FIG. 1, where a main output voltage Vₒ₁, measured on a utilizer device (load) 5, is controlled by a fixed frequency pulsed width modulation (PWM) structure, designated 10 as a whole. A pulsed width modulation controller 15 senses the voltage Vₒ₁ and regulates it by reacting to any variations in an input voltage Vᵢₙ in a typical closed loop arrangement. Additionally, the main output voltage Vₒ₁ is regulated on the basis of load variations, and in particular depending on the variations in the load device 5.

In the arrangement shown in FIG. 1, any variation in input voltage Vᵢₙ is balanced by the action of the pulsed width modulation structure 10 for all the outputs. Conversely, any change in the output Vₒ₂ or in the output Vₒ₃ is not taken into account by the pulsed width modulation controller 15 because the two outputs Vₒ₂ and Vₒ₃ are operated essentially in an open loop configuration.

In order to keep the output voltages Vₒ₂ and Vₒ₃ under regulation, even with respect to load changes, a so-called “post-regulator” 20 is needed in the second and in the third branch of the FIG. 1.

The most popular “post-regulator” types include linear regulators, post DC/DC (direct current) converters, and magnetic amplifiers (mag-amps). All these solutions exhibit advantages and drawbacks as well.

A linear regulator is a very simple solution, inexpensive and easy to design. A major disadvantage lies in poor efficiency, and for that reason linear regulators are used in “very low” and “low” current applications, where they can be considered the best solution.

Cascading DC/DC converters to the outputs is another method to regulate multiple output voltages. The main advantages of this solution are efficiency, good voltage regulation performance and current capability. However, this technique presents several drawbacks, first of all the supplementary cost of an additional complete DC/DC converter, which includes power switches, inductors, capacitors and controllers. Furthermore, an additional DC/DC converter generates added noise and added ripple current, which poses stricter requirements in terms of filter components or synchronization with the main pulsed width modulation.

Magnetic amplifiers can be described as “post-regulators” with a programmable delay switch. These probably represent the most common solution for “medium-power” and “high-power” post regulation. The main component of a magnetic amplifier regulator is a saturable reactor that acts as a magnetic switch, exhibiting high-impedance characteristics during the blocking period (switch “off”) and low-impedance characteristics when in saturation (switch “on”). A magnetic amplifier has usually associated a simple control circuitry, and exhibits very good and “rugged” regulation performance. The main drawbacks of magnetic amplifiers include poor regulation at reduced or no load, limitations on switching frequency and size.

Another kind of solution is a pulsed width modulation (PWM) “post-regulator”. This solution is suitable for any range of power applications, but is more convenient when used in “medium-power” and “high-power” applications, so this is an alternative to the magnetic amplifier circuit. This device is a pulsed width modulation controller synchronized with the primary pulsed width modulation controller and working in leading edge modulation, using a switch (bipolar transistor, MOSFET, etc.) in order to block the voltage on the secondary winding of the transformer. The advantages of this approach with respect to the solutions involving a magnetic amplifier are: lower cost, lower size, higher reliability, and better performance. The circuitry necessary to control the switch may be complicated, but the eventual integration of this circuitry in one chip makes this drawback negligible.

Certain devices already exist in the market that implement this kind of approach. Exemplary of these are CS5101 by ON Semiconductor (to which U.S. Pat. No. 5,955,910 corresponds), and Unitrode UCC1583/2583/3583 by Texas Instruments.

The operation mode of the pulsed width modulation post-regulator controller is similar to the operation mode of a “buck” converter, which is a switching dc/dc converter that converts a dc input voltage to an output voltage with a lower DC value. The pulsed width modulation post-regulator controller controls a switch, which has the capability of blocking some values of the input voltage, providing a smaller duty-cycle in the output voltage than in the input voltage. The value of the voltage obtained via blocking depends on the controller feedback loop that controls the output voltage by turning the output voltage on and off.

FIG. 2 shows a typical application in a multiple-output forward converter of the type considered in the foregoing, which can be considered as a particular implementation of the system depicted in FIG. 1. There, a voltage V_{d2} across a diode 32 is a pulse width modulated (PWM) waveform able to provide a DC output Vₒ. More in detail, associated with the diode 32 is an LC low-pass filter including an inductor 35a and a capacitor 35b. The voltage Vₒ is established across the capacitor 35b.

The pulse width of the voltage V_{d2} across the diode 32 is controlled by the duty-cycle of a main electronic switch 36, and by the operation of a controlled switch 31. Specifically, the switch 36 is connected in series to the primary winding of a transformer T connected to the input voltage Vᵢₙ. The transformer T includes two secondary windings one of which, indicated 33 in FIG. 2, produces a voltage Vₛ₁ which is transferred to the diode 32 via the controlled switch 31.

When the controlled switch 31 is off (i.e. open), the switch blocks (i.e. separates) the voltage Vₛ₁ across the secondary winding 33 of the transformer T from the output LC filter (35a, 35b), presenting high impedance.

When the controlled switch 31 is on (i.e. closed), its impedance is very low and it blocks very little voltage, and the voltage Vₛ₁ appears across the catch diode 32.

While the voltage output Vₒ is primarily controlled by the operation of a post-regulator controller 37 that controls the switch 31, another voltage output Vₒ′ produced at a substantially similar circuit 38 associated with a further secondary winding of the transformer T is controlled by a primary pulsed width modulation circuit 15 acting on the switch 36.

FIG. 3 shows two waveforms Vₛ₁ and Vₛ₂ of the post-regulator controller circuit 37 of FIG. 2, and the associated state of the switch for a continuous inductor conduction mode (CCM). The voltage Vₛ₁ is the voltage waveform present across the secondary winding 33 of the transformer, while tₒₙ₁ and t_{off} are the “on-time” and the “off-time” of the primary switch 36, respectively, and finally Tₛ represents the entire switching period. A parameter T_{b} represents the time during which the controlled switch 31 is off. The period during which the controlled switch 31 is on and the input to output power transfer occurs is represented by tₒₙ₂. The positive voltage Vₛ₁ makes a current I_{L}, in an inductor 35, to rise. During the test of the period (t_{off}+t_{b}), the controlled switch 31 is off.

A discontinuous inductor conduction mode (DCM) situation is shown in FIG. 4. All the considerations made for the continuous inductor conduction mode (CICM) operation mode are still valid. In this case, neglecting parasitic elements, a positive voltage equal to Vₒ appears in the V_{d2} voltage during the dead time (t_{d}) in which the inductor current I_{L} is zero.

This kind of post-regulator can be used also in double-ended forward-derived topologies as push-pull, half-bridge, and full-bridge.

The CS5101 device already mentioned in the foregoing includes the functionalities to implement the pulsed width modulation post regulation. This device in fact implements all the functions assumed to be performed by the block 37 in FIG. 2.

Apart of the standard pulsed width modulation blocks, the device includes:

a bootstrap drive for the switch;

an over current protection control implemented with a typical operational amplifier.

Other detailed information can be found in the following documents:

ON Semiconductor Datasheet: CS5101, Secondary Side Post regulator (SSPR) far Switching Power Supplies with Multiple Outputs;

U.S. Pat. No. 5,955,910;

Texas Instruments-Unitrode Datasheet: UCC1583, UCC2583, UCC3583, Switch Mode Secondary Side Post Regulator;

Texas Instruments-Unitrode Datasheet: UCC1584, UCC2584, UCC3584, Switch Mode Secondary Side Post Regulator; and

U.S. Pat. No. 5,986,911.

### BRIEF SUMMARY OF THE INVENTION

While such prior art arrangements are per se capable of providing satisfactory results, the need is felt for an improved solution adapted to ensure a simple and low-cost circuit for controlling multi-output voltages.

One embodiment of the invention provides a fully satisfactory response to this need.

One embodiment of the present invention is a circuit having the features set forth in the claims that follow.

The claims are an integral part of the disclosure of the invention provided herein.

A preferred embodiment of the exemplary circuit described herein is adapted to be used in multiple-output switched mode power supplies in order to achieve tight regulation of an auxiliary output by using a switch controlled by a pulse width modulated controller synchronized with a primary pulse width modulated controller. The controlled switch has the capability of blocking a certain part of the voltage value applied across it. The integrated circuit is able to control the switch with a leading edge pulse width modulation technique in order to guarantee the output voltage regulation.

A preferred embodiment of the integrated circuit described herein also controls a free-wheeling switch (usually an N-channel MOSFET) to implement a synchronous rectification technique and so improving the efficiency of the converter. During light load operation the free-wheeling switch is turned off in order to prevent reverse current conduction.

The solution described herein extends and improves performance of prior art devices such as e.g. the CS5101 device, as described in U.S. Pat. No. 5,955,910, by introducing dedicated pins to implement a synchronous rectification function while at the same time assuring proper operation in discontinuous conduction mode.

The arrangement described herein includes all the functionalities of prior art devices such as e.g. the CS5101 device, but improves their performance by including:

dedicated driving for free-wheeling synchronous MOSFET; this improves the overall efficiency of the converter;

shoot-through protection circuit to avoid short circuit on the secondary side between the control switch and the free-wheeling MOSFET; and

a dedicated pin to select the output current value at which the synchronous rectifier starts to be driven: this allows correct operation in discontinuous conduction mode.

### BRIEF DESCRIPTION OF THE SEVERAL VIEWS OF THE DRAWINGS

The invention will now be described, by way of example only, with reference to the enclosed figures of drawing, wherein:

FIGS. 1 to 4, related to the prior art, have already been described in the foregoing;

FIG. 5 shows how the arrangement of FIG. 2 can be modified to take full advantage of the solution described herein;

FIG. 6 shows an exemplary embodiment of the solution described herein;

FIG. 7 shows an exemplary timing of two drive signals generated in the arrangement of FIG. 6.

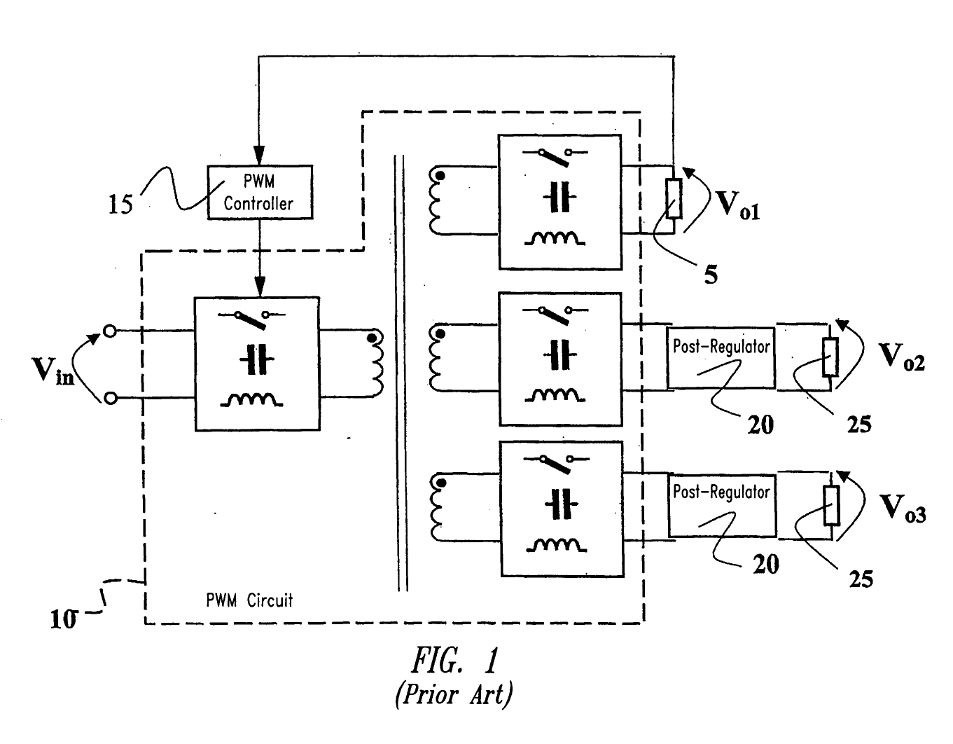

### DETAILED DESCRIPTION OF THE INVENTION

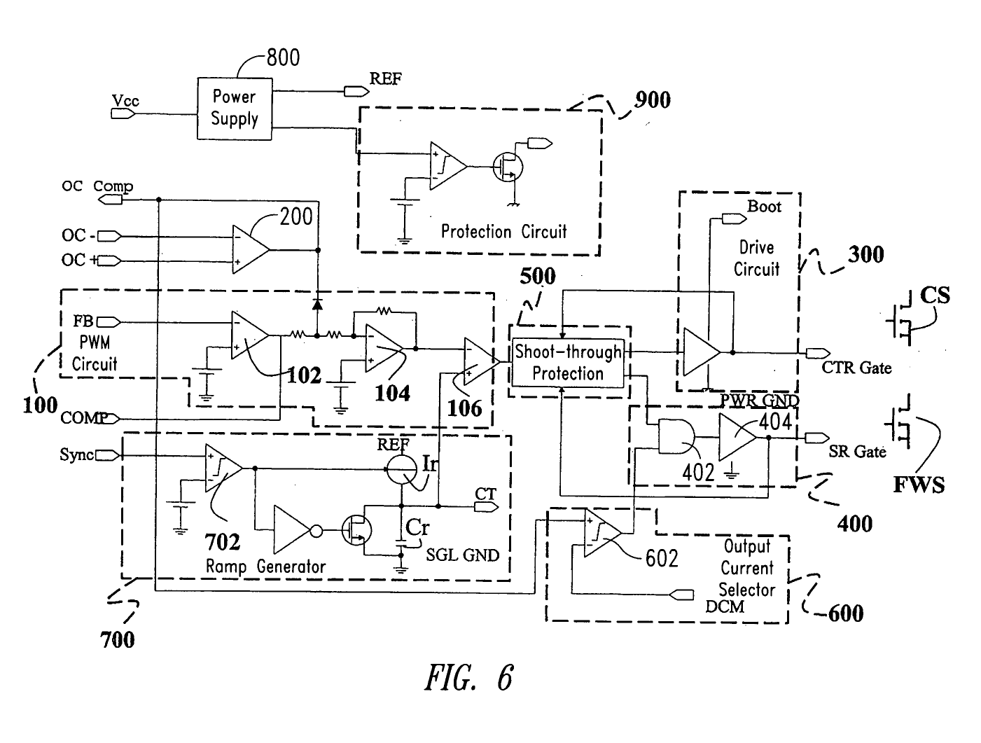

An exemplary embodiment of the arrangement described herein is in the form of an integrated circuit whose block diagram is shown in FIG. 6.

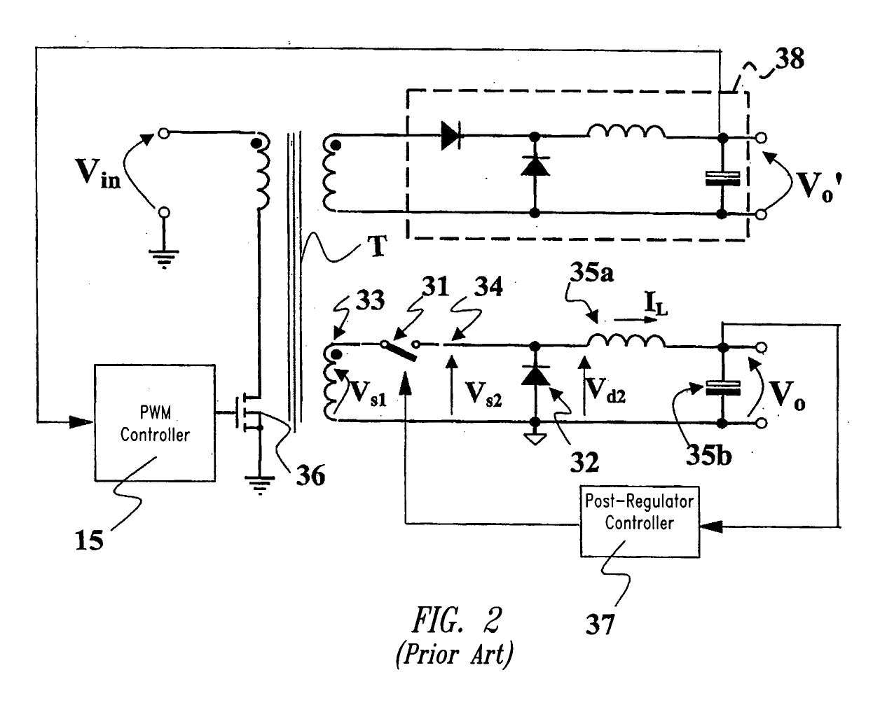

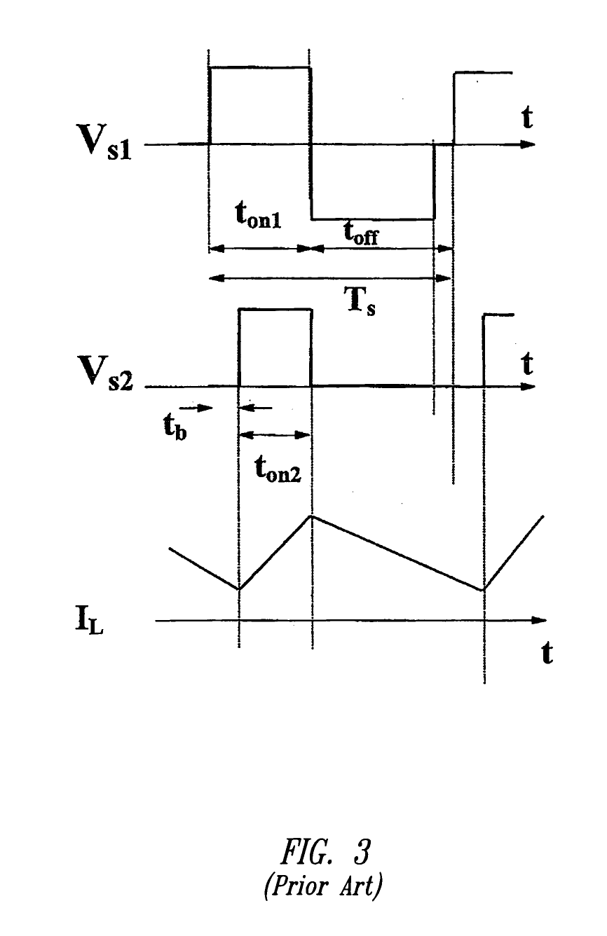

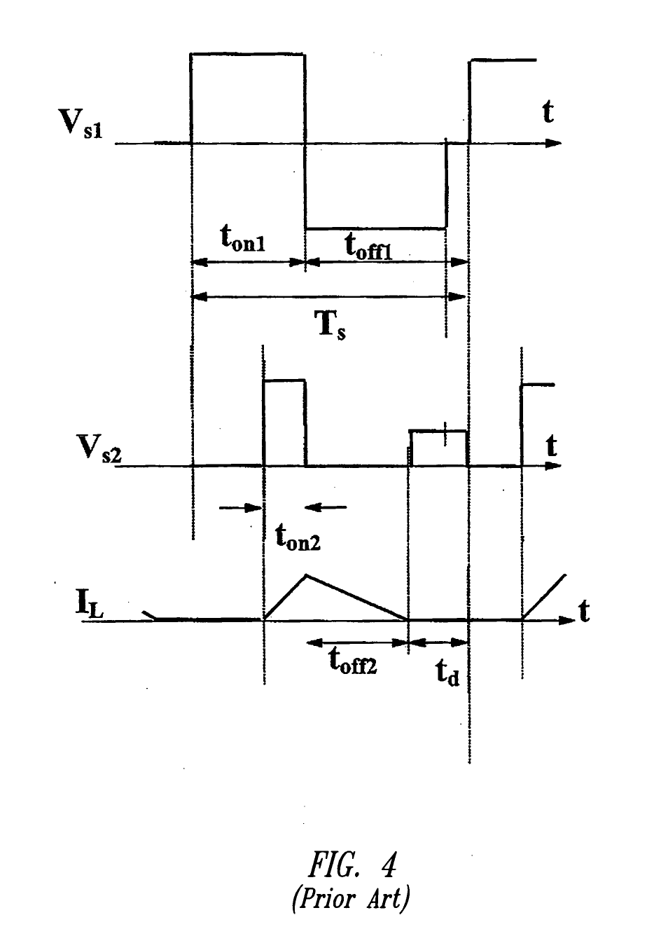

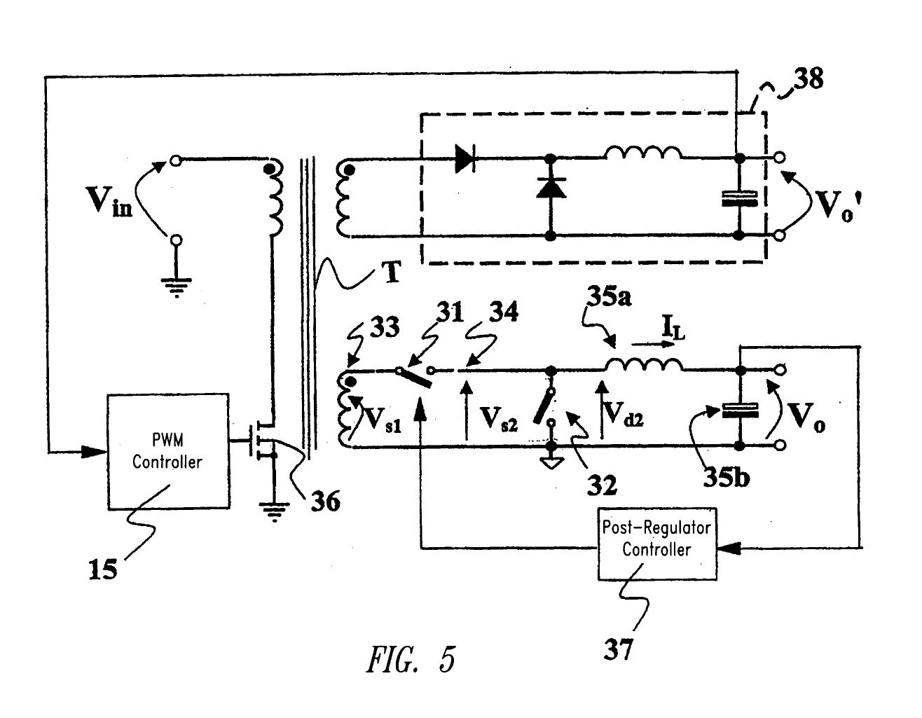

Essentially the integrated circuit in question can be used within the framework of an arrangement of the type shown in FIG. 2, preferably modified as shown in FIG. 5, i.e. by implementing a synchronous rectification function by means of a free-wheeling switch 320, i.e., an active controlled switch that replaces the diode 32 of FIG. 2 while at the same time assuring proper operation in discontinuous conduction mode.

Stated otherwise, the main purpose of the circuit shown in FIG. 6 is to synchronize/control operation of the switch 31 and of the switch 320 in order to improve the overall efficiency of the system according to the well-known synchronous rectification technique.

The block diagram of FIG. 6 includes the following elements:

a standard pulse width modulated architecture 100, adapted to be connected to an input terminal FB to be synchronized with the voltage on the secondary winding of a switched mode power supply (not shown, but of known type—see the introductory portion of this description); this architecture includes a voltage comparator 102, an error amplifier 104 and a PWM comparator 106;

an error amplifier 200 operating in a typical over current control circuit and connected via terminals OC− and OC+ to an output current sense resistor (not shown, but connected to the inductor IL to sense the current through the inductor;

a drive circuit 300 having a terminal CTR Gate to be connected to a control terminal of a control switch CS (e.g., the switch 31 of FIGS. 2 and 5) and including a bootstrap terminal (Boot) to drive a high side N-Channel MOSFET;

a low-side driving circuit 400 including a terminal (SR Gate) to drive a control terminal of a free-wheeling synchronous rectified active switch FWS (i.e. the switch 320 shown in FIG. 5 that replaces the diode shown in the same position in FIG. 2);

a shoot-through protection circuit 500 which avoids any cross conduction between the two switches CS and FWS (that are the controlled switch 31 and the free-wheeling synchronous switch 320 shown in FIG. 5);

a dedicated circuit 600 to select the level of the output current at which the synchronous switch must be enabled - this level is sensed on an input terminal DCM;

a ramp generator circuit 700 whose detailed operation is described below;

an internal power supply block 800 that supplies power to the whole circuit; and

a protection circuit 900 that keeps the control switch off when the circuit is not supplied correctly (for example during start-up).

Device synchronization is accomplished through a Sync pin included in the ramp generator circuit 700. The Sync pin is connected to the secondary winding of the transformer T. When a threshold of a first comparator 702 is reached a current generator Ir starts charging a capacitor Cr. The charge is stopped when the threshold of the first comparator 702 is crossed again in the falling edge. The resulting voltage ramp is supplied to the PWM comparator 106.

The PWM comparator 106 receives on the inverting input an error signal coming from the error amplifier 102 combined with a signal coming from the over current amplifier 200. The output of the PWM comparator 106 is the input of the shoot-through protection circuit 500.

The circuit 500 has the task of providing the correct drive signals for both the controlled switch CS and the free-wheeling switch FWS connected to the terminals CTR Gate and SR Gate, respectively. By sensing the gate voltages, the circuit 500 enables turn-on of each switch some time after the other switch has been turned off. This prevents any possibility of simultaneous conduction between the two switches CS and FWS.

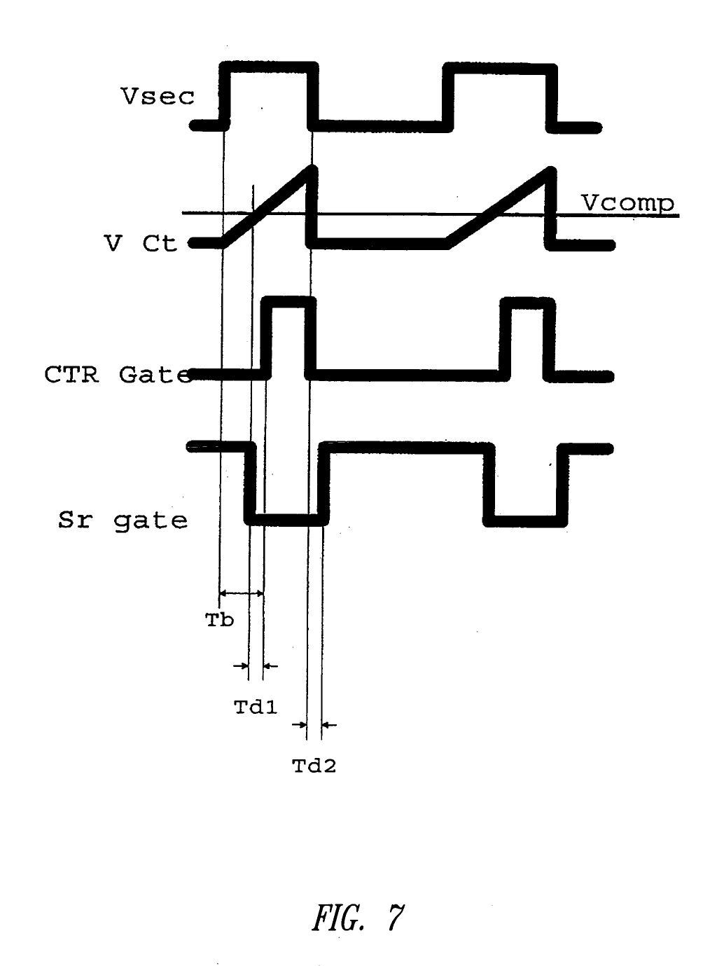

A detailed timing of the two drive signals is shown in FIG. 7. The driving output stage includes a high side driving stage 300 with bootstrap for the controlled switch CS, 31 and a simple low-side driving stage 400 for the free-wheeling switch FWS, 320.

A common problem in synchronous rectified topologies is operation in the discontinuous conduction mode.

During no load or light load operation the inductor current reach zero before a new switching period begins. Using common diode rectification, this current cannot become negative because the diode itself does not allow the current to change its direction. But in synchronous rectification application, when the current reaches zero, if the synchronous MOSFET is on, the current starts to reverse flowing in the opposite direction. This, in general, is not a preferred behavior for some reasons:

worsening of the power consumption performance during light load and no load. This operation does not allow meeting international rules on stand-by power consumption;

possibility to sink current from other power supplies connected in parallel.

The arrangement described herein overcomes all these drawbacks. The non-inverting input of a comparator 602 in the block 600 is connected to the output of the current amplifier 200, while the inverting input, which is available externally, is supplied by a constant DCM voltage. The output of the comparator 602 is connected to an AND gate 402 of the driving circuit 400. When the output current is decreasing (i.e. the discontinuous mode is approaching) then the output of the current amplifier decreases. When the output voltage of the current amplifier 200 goes below the voltage DCM at the inverting input of the comparator 602, the output of the comparator goes low. This signal causes the output of the AND gate 402 which causes a driver 404 of the driving circuit to drive low the free-wheeling drive signal at the SR gate. In this way the free-wheeling synchronous MOSFET switch FWS, 320 is off and the secondary current is carried by the body-diode.

The amount of output current, which determines the turn-off of the free-wheeling gate, is determined by the DCM voltage at the inverting pin of the comparator 602, and can be set externally with a resistor divider connected to the reference voltage.

In the solution described herein the synchronous free-wheeling switch FWS is driven by an N-channel MOSFET (not shown) of the driver 404 and the integrated circuit takes care of driving the MOSFET in a proper way

The introduction of a free-wheeling synchronous MOSFET FWS, 320 makes possible the output current to be reversed during light or no load condition. The circuit described is able to determine when the current is decreasing in order to turn-off the MOSFET avoiding any possibility to have reverse current. This functionality is also externally adjustable with a resistor divider.

Synchronous rectification is a common technique to increase the efficiency of the switched mode power supply. But this technique usually is quite complex to be implemented specially in isolated topologies. The arrangement described herein allows implementing this function without any efforts by the end-user, in fact, the integrated circuit is able to provide the correct drive signals in all conditions.

The arrangement disclosed is able to automatically turn off the synchronous MOSFET when the output current is low, this allow saving power and avoiding current to be sunk when other switched mode power supplies are connected in parallel to the output.

Moreover, the turn off threshold can be adjusted with a very simple circuit giving the maximum flexibility in all application conditions.

Without prejudice to the underlying principles of the invention, the details and the embodiments may vary, also appreciably, with reference to what has been described by way of example only, without departing from the scope of the invention as defined by the annexed claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A control circuit for a pulsed width modulation controller including a main controlled switch to selectively block an energization signal from a switched mode power supply, and a free-wheeling synchronous switch for selectively transferring said energization signal as an output signal, the control circuit comprising:
a pulse width modulated module having an input terminal for connection with said switched mode power supply to achieve synchronization with said switched mode power supply, said pulse width modulated module including a PWM comparator;
a drive circuit for said main controlled switch, the drive circuit being controlled by said PWM comparator;
a low-side drive circuit for said free-wheeling synchronous switch controlled by said PWM comparator; and
a ramp generator having a synchronization terminal for connection to said switched mode power supply, said ramp generator producing a ramp signal and including a comparator that senses a signal on said synchronization terminal, said ramp generator being configured for being activated and de-activated on raising and falling edges of said signal on said synchronization terminal, the ramp signal from said ramp generator defining a threshold of said PWM comparator to thereby control operation of said drive circuit for said main switch and said low-side drive circuit for said free-wheeling synchronous switch.

2. The control circuit of claim 1, further comprising a protection circuit interposed between said PWM comparator and said main controlled switch and said free-wheeling synchronous switch, said protection circuit being structured to prevent cross-conduction between said main controlled switch and said free-wheeling synchronous switch.

3. The control circuit of claim 2, wherein said protection circuit is configured for enabling turn-on of either of said main controlled switch and said free-wheeling synchronous switch after the other of said main controlled switch and said free-wheeling synchronous switch has been turned off.

4. The control circuit of claim 2 wherein said main controlled switch and said free-wheeling synchronous switch are electronic switches provide with respective gates, and said protection circuit senses gate voltages of said main controlled switch and said free-wheeling synchronous switch.

5. The control circuit of claim 1 wherein said pulse width modulated module includes a cascaded arrangement of a voltage comparator, an error amplifier and said PWM comparator.

6. The control circuit of claim 1, further comprising an amplifier for sensing an output current from said PWM controller in an over current control arrangement, wherein said PWM comparator receives as an input a signal coming from said amplifier.

7. The control circuit of claim 1 wherein said drive circuit for said main controlled switch includes a bootstrap terminal to drive an N-channel MOSFET.

8. The control circuit of claim 1, further comprising a dedicated circuit for selecting a level of said output signal at which said free-wheeling synchronous switch is enabled.

9. The control circuit of claim 1, further comprising an internal power supply block that supplies power to the control circuit.

10. The control circuit of claim 1, further comprising a protection circuit that keeps off said main controlled switch when the circuit is not correctly supplied.

11. The control circuit of claim 1 formed as an integrated circuit on a single semiconductor chip.

12. A control circuit, comprising:
an input terminal for receiving an energization signal from a switched mode power supply;
a first switch connected between the input terminal and a first node, and including a control terminal;
a second switch connected between the first node and a voltage reference, and including a control terminal;
an inductor connected between the first node and an output terminal; and
a controller having an input coupled the output terminal and first and second outputs respectively connected to the control terminals of the first and second switches, the controller being structured to control the first and second switches based on a synchronization signal from the switched mode power supply.

13. The control circuit of claim 12 wherein the controller includes:
a pulse width modulated module having an input terminal for connection with the switched mode power supply to achieve synchronization with the switched mode power supply, the pulse width modulated module including a PWM comparator;
a first drive circuit that drives the first switch, the first drive circuit being controlled by the PWM comparator;
a second drive circuit that drives the second switch, the second drive circuit being controlled by the PWM comparator; and
a ramp generator having a synchronization terminal for connection to the switched mode power supply, the ramp generator producing a ramp signal and including a comparator that senses a signal on the synchronization terminal, the ramp generator being configured for being activated and de-activated on raising and falling edges of the signal on the synchronization terminal, the ramp signal from the ramp generator defining a threshold of the PWM comparator to thereby control operation of the first and second drive circuits.

14. The control circuit of claim 12, further comprising a protection circuit interposed between the PWM comparator and the first and second switches, the protection circuit being structured to prevent cross-conduction between the first switch and the second switch.

15. The control circuit of claim 14 wherein the protection circuit has first and second inputs respectively connected to the control terminals of the first and second switches, the protection circuit being structured to prevent cross-conduction between the first and second switches based on control voltages at the control terminals of the first and second switches.

16. The control circuit of claim 12 wherein the controller includes:
an amplifier having an input coupled to the output terminal and an output at which the amplifier provides a sense signal indicative of a current at the output terminal;
a comparator having a first input coupled to the output of the amplifier, a second input coupled to a threshold voltage, and an output; and
a drive circuit having an input coupled to the output of the comparator and an output coupled to the control terminal of the second switch, the comparator being structured to cause the drive circuit to turn off the second switch in response to the sense signal falling below the threshold voltage.

17. A control circuit for a pulsed width modulation (PWM) controller including a first switch to selectively block an energization signal from a switched mode power supply, and a free-wheeling, synchronous second switch for selectively transferring the energization signal as an output signal, the control circuit comprising:
a PWM circuit having an input coupled to the switched mode power supply and an output that provides a control signal that is synchronized based on a synchronization signal from the switched mode power supply;
a first drive circuit having an input coupled to the output of the PWM circuit and an output for driving the first switch;
a second drive circuit having an input coupled to the output of the PWM circuit and an output for driving the second switch;
a sense circuit structured provide a sense signal indicative of a current of the output signal; and
a comparator coupled to having a first input coupled to the output of the amplifier, a second input coupled to a threshold voltage, and an output, the comparator being structured to cause the second drive circuit to turn off the second switch in response to the sense signal falling below the threshold voltage.

18. The control circuit of claim 17, wherein the PWM circuit includes a PWM comparator, the control circuit further comprising:
a ramp generator having a synchronization terminal for connection to the switched mode power supply, the ramp generator producing a ramp signal and including a comparator that senses a signal on the synchronization terminal, the ramp generator being configured for being activated and de-activated on raising and falling edges of the signal on the synchronization terminal, the ramp signal from the ramp generator defining a threshold of the PWM comparator to thereby control operation of the first and second drive circuits.

19. The control circuit of claim 17, further comprising a protection circuit interposed between the PWM circuit and the first and second switches, the protection circuit being structured to prevent cross-conduction between the first switch and the second switch.

20. The control circuit of claim 19 wherein the protection circuit has first and second inputs respectively connected to control terminals of the first and second switches, the protection circuit being structured to prevent cross-conduction between the first and second switches based on control voltages at the control terminals of the first and second switches.
